(19) United States
(12) Patent Application Publication
(10) Pub. No.: US 2024/0078601 A1
(43) Pub. Date: Mar. 7, 2024

(54) METHOD, APPARATUS, SYSTEM, AND NON-TRANSITORY COMPUTER READABLE MEDIUM FOR PERFORMING CO-TRADING CHANGEPOINT DETECTION

(71) Applicant: Charles Schwab & Co., Inc., San Francisco, CA (US)

(72) Inventors: Sean Ming-Yin LAW, Ann Arbor, MI (US); Kim CHEN, San Francisco, CA (US)

(73) Assignee: Charles Schwab & Co., Inc., San Francisco, CA (US)

(21) Appl. No.: 17/894,304

(22) Filed: Aug. 24, 2022

(51) Int. Cl. G06Q 40/04

(52) U.S. Cl. CPC G06Q 40/04

(57) ABSTRACT

A system, apparatus, method, and non-transitory computer readable medium for performing co-trading changepoint detection may include a server caused to receive a first raw dataset, the first raw dataset including a plurality of transactions for analysis, each transaction of the plurality of transactions associated with a user account of a plurality of user accounts, generate at least one transaction time series based on the first raw dataset, determine changepoints in the first raw dataset by performing changepoint detection analysis on the generated at least one transaction time series, and generate at least one potential fraud alert based on the determined changepoints.

### BACKGROUND

### Field

Various example embodiments relate to methods, apparatuses, systems, and/or non-transitory computer readable media for performing co-trading changepoint detection, and more particularly, methods, apparatuses, systems, and/or non-transitory computer readable media for determining potential victims of fraud, price manipulation, insider trading, and/or other illegal activity based on detection of abnormal trading patterns using changepoint detection on co-trading time series data.

### Description of the Related Art

Investors may use brokerage firms and/or security exchanges to execute security trading transactions, such as sales of stocks, bonds, commodities, options, futures, etc. However, the price of securities may be subject to market manipulation, wherein a party may artificially affect the supply or demand for a security, thereby causing the price for the security to dramatically rise or fall. At particular risk for market manipulation are low-priced securities, securities with limited liquidity, and/or securities which have limited publicly available information, such as penny stocks, micro-cap stocks, and new security types (e.g., digital assets, etc.). An example of a market manipulation technique includes pump-and-dump manipulations, wherein one or more parties purchases shares of a security, spreads false and/or misleading information regarding the security to artificially increase demand for the security which inflates the price of the security, before selling the security at the artificially inflated price. Other examples of market manipulation techniques include engaging in a series of transactions involving the security to make the security appear more active, engaging in order spoofing by making numerous transaction orders to move the price of the security before cancelling the spoofed orders, etc.

Conventional techniques to detect potentially fraudulent, artificial, and/or illegal market manipulation relied upon analyzing the transactions of individual securities. For example, some conventional techniques centered on detecting spikes in trading activity and/or spikes in price for individual securities, and/or detecting single-point outliers in the number of transactions, price, and/or volume of individual securities. However, these conventional detection techniques suffer from high false-positive rates due to the difficulties in detecting artificial changes in security transaction behavior from natural changes and/or legal changes in security transaction behavior, such as pricing changes reflecting increased transactions which are in response to company earnings-related news, pricing changes corresponding to regulatory and/or legal announcements affecting the security, pricing changes corresponding to national events and/or world events affecting the security, etc.

Accordingly, an approach is desired that provides improved, more efficient, and/or more accurate detection of artificial market manipulation of securities. Additionally, an approach is desired to identify potential victims of artificial market manipulation and/or identify the parties perpetrating artificial market manipulation.

### SUMMARY

At least one example embodiment is directed towards a server for performing co-trading changepoint detection.

In at least one example embodiment, the server may include a memory storing computer readable instructions, and processing circuitry configured to execute the computer readable instructions to cause the server to, receive a first raw dataset, the first raw dataset including a plurality of transactions for analysis, each transaction of the plurality of transactions associated with a user account of a plurality of user accounts, generate at least one transaction time series based on the first raw dataset, determine changepoints in the first raw dataset by performing changepoint detection analysis on the generated at least one transaction time series, and generate at least one potential fraud alert based on the determined changepoints.

Some example embodiments provide that the server is further caused to, receive a desired set of filtering parameters, the desired set of filtering parameters including at least a set of desired transaction object identifiers and a desired transaction type identifier, and filter the first raw dataset using the desired set of filtering parameters to form a filtered first dataset.

Some example embodiments provide that the server is further caused to, receive a desired set of time series parameters, the desired set of time series parameters including a desired analysis sliding time window size, and a desired co-tuple size, the desired co-tuple size being an integer greater than 1, and generate the at least one transaction time series based on the filtered first dataset and the desired set of time series parameters.

Some example embodiments provide that the server is further caused to, for each user account included in the filtered first dataset, generate a second set of transactions from the filtered first dataset, each of the second set of transactions associated with the user account, determine at least one co-tuple group, the at least one co-tuple group being a combination of transaction object identifiers from the set of desired transaction object identifiers based on the desired co-tuple size, for each co-tuple group, determine co-tuple group transactions from the second set of transactions associated with transaction object identifiers included in the co-tuple group based on the desired analysis slide time window size, and generate the at least one transaction time series by aggregating the determined co-tuple group transactions associated with the user account.

Some example embodiments provide that the server is further caused to, receive a desired set of changepoint parameters, the desired set of changepoint parameters including at least a desired probability distribution type, a desired set of hyperparameters associated with the desired probability distribution type, and a desired hazard function, for each co-tuple transaction included in the generated at least one transaction time series, calculate a predicted probability value of the co-tuple transaction based on the desired probability distribution type and the desired set of hyperparameters, determine a growth probability value of the co-tuple transaction based on the calculated predicted probability value, a current changepoint run length, and the desired hazard function, calculate a changepoint probability value of the co-tuple transaction based on the determined growth probability value and a sum of the calculated predicted probability values of previous co-tuple transactions of the current changepoint run length, and determine whether the co-tuple transaction is a changepoint based on the calculated changepoint probability value and a desired changepoint threshold value, and store the determined changepoints.

Some example embodiments provide that the server is further caused to, receive new transactions for analysis in real-time, update the at least one transaction time series based on the received new transactions, and determine new changepoints based on the updated at least one transaction time series and the stored determined changepoints.

Some example embodiments provide that the server is further caused to, identify the user accounts associated with the transactions corresponding to the determined changepoints, and generate the at least one potential fraud alert, the at least one potential fraud alert including the identified user accounts and the transactions corresponding to the determined changepoints.

Some example embodiments provide that the server is further caused to, transmit the at least one potential fraud alert to at least one of the user account associated with the potential fraud alert, a fraud investigation service, a government agency, or any combinations thereof.

At least one example embodiment is directed towards a method for performing co-trading changepoint detection.

In at least one example embodiment, the method may include receiving a first raw dataset, the first raw dataset including a plurality of transactions for analysis, each transaction of the plurality of transactions associated with a user account of a plurality of user accounts, generating at least one transaction time series based on the first raw dataset, determining changepoints in the first raw dataset by performing changepoint detection analysis on the generated at least one transaction time series, and generating at least one potential fraud alert based on the determined changepoints.

Some example embodiments provide that the method further includes, receiving a desired set of filtering parameters, the desired set of filtering parameters including at least a set of desired transaction object identifiers and a desired transaction type identifier, and filtering the first raw dataset using the desired set of filtering parameters to form a filtered first dataset.

Some example embodiments provide that the method further includes, receiving a desired set of time series parameters, the desired set of time series parameters including a desired analysis sliding time window size, and a desired co-tuple size, the desired co-tuple size being an integer greater than 1, and generating the at least one transaction time series based on the filtered first dataset and the desired set of time series parameters.

Some example embodiments provide that the method further includes, for each user account included in the filtered first dataset, generating a second set of transactions from the filtered first dataset, each of the second set of transactions associated with the user account, determining at least one co-tuple group, the at least one co-tuple group being a combination of transaction object identifiers from the set of desired transaction object identifiers based on the desired co-tuple size, for each co-tuple group, determining co-tuple group transactions from the second set of transactions associated with transaction object identifiers included in the co-tuple group based on the desired analysis slide time window size, and generating the at least one transaction time series by aggregating the determined co-tuple group transactions associated with the user account.

Some example embodiments provide that the method further includes, receiving a desired set of changepoint parameters, the desired set of changepoint parameters including at least a desired probability distribution type, a desired set of hyperparameters associated with the desired probability distribution type, and a desired hazard function, for each co-tuple transaction included in the generated at least one transaction time series, calculating a predicted probability value of the co-tuple transaction based on the desired probability distribution type and the desired set of hyperparameters, determining a growth probability value of the co-tuple transaction based on the calculated predicted probability value, a current changepoint run length, and the desired hazard function, calculating a changepoint probability value of the co-tuple transaction based on the determined growth probability value and a sum of the calculated predicted probability values of previous co-tuple transactions of the current changepoint run length, and determining whether the co-tuple transaction is a changepoint based on the calculated changepoint probability value and a desired changepoint threshold value, and storing the determined changepoints.

Some example embodiments provide that the method further includes, receiving new transactions for analysis in real-time, updating the at least one transaction time series based on the received new transactions, and determining new changepoints based on the updated at least one transaction time series and the stored determined changepoints.

Some example embodiments provide that the method further includes, identifying the user accounts associated with the transactions corresponding to the determined changepoints, and generating the at least one potential fraud alert, the at least one fraud alert including the identified user accounts and the transactions corresponding to the determined changepoints.

At least one example embodiment is directed to a non-transitory computer readable medium.

In at least one example embodiment, the non-transitory computer readable medium stores computer readable instructions, which when executed by processing circuitry of a server, causes the server to, receive a first raw dataset, the first raw dataset including a plurality of transactions for analysis, each transaction of the plurality of transactions associated with a user account of a plurality of user accounts, generate at least one transaction time series based on the first raw dataset, determine changepoints in the first raw dataset by performing changepoint detection analysis on the generated at least one transaction time series, and generate at least one potential fraud alert based on the determined changepoints.

Some example embodiments provide that the server is further caused to, receive a desired set of filtering parameters, the desired set of filtering parameters including at least a set of desired transaction object identifiers and a desired transaction type identifier, and filter the first raw dataset using the desired set of filtering parameters to form a filtered first dataset.

Some example embodiments provide that the server is further caused to, receive a desired set of time series parameters, the desired set of time series parameters including a desired analysis sliding time window size, and a desired co-tuple size, the desired co-tuple size being an integer greater than 1, and generate the at least one transaction time series based on the filtered first dataset and the desired set of time series parameters.

Some example embodiments provide that the server is further caused to, for each user account included in the filtered first dataset, generate a second set of transactions from the filtered first dataset, each of the second set of transactions associated with the user account, determine at least one co-tuple group, the at least one co-tuple group being a combination of transaction object identifiers from the set of desired transaction object identifiers based on the desired co-tuple size, for each co-tuple group, determine co-tuple group transactions from the second set of transactions associated with transaction object identifiers included in the co-tuple group based on the desired analysis slide time window size, and generate the at least one transaction time series by aggregating the determined co-tuple group transactions associated with the user account.

Some example embodiments provide that the server is further caused to, receive a desired set of changepoint parameters, the desired set of changepoint parameters including at least a desired probability distribution type, a desired set of hyperparameters associated with the desired probability distribution type, and a desired hazard function, for each co-tuple transaction included in the generated at least one transaction time series, calculate a predicted probability value of the co-tuple transaction based on the desired probability distribution type and the desired set of hyperparameters, determine a growth probability value of the co-tuple transaction based on the calculated predicted probability value, a current changepoint run length, and the desired hazard function, calculate a changepoint probability value of the co-tuple transaction based on the determined growth probability value and a sum of the calculated predicted probability values of previous co-tuple transactions of the current changepoint run length, and determine whether the co-tuple transaction is a changepoint based on the calculated changepoint probability value and a desired changepoint threshold value, and store the determined changepoints.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a system associated with an online trading platform according to at least one example embodiment;

FIG. 2 illustrates a block diagram of an example computing device of the online trading platform according to at least one example embodiment;

FIG. 3A illustrates an example method for performing co-trading changepoint detection according to at least one example embodiment;

FIGS. 3B to 3D are example graphs illustrating a co-trading dataset and results of changepoint analysis on the co-trading dataset according to at least one example embodiment;

FIG. 4A illustrates an example method for generating a co-trading time-series according to at least one example embodiment;

FIG. 4B illustrates an example first raw dataset including a plurality of transactions according to at least one example embodiment;

FIG. 4C illustrates an example co-trading transaction time series associated with a user account according to at least one example embodiment;

FIG. 5 illustrates an example method for performing offline changepoint analysis using a co-trading time series according to at least one example embodiment; and

FIG. 6 illustrates an example method for performing online changepoint analysis using a co-trading time series according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

At least one example embodiment refers to methods, systems, devices, and/or non-transitory computer readable media for performing co-trading changepoint detection to detect artificial market manipulation and/or potential artificial market manipulation in the price of co-traded securities, e.g., fraudulent and/or potentially fraudulent price manipulation, pump-and-dump activity, etc., on two or more securities traded over a desired sliding time period, which provides improved accuracy and/or reduced false-positive detection rates over conventional detection techniques, etc. The Inventors have discovered that artificial price manipulators typically attempt to manipulate the price of a plurality of securities during a common and/or same time period (e.g., perform “pump-and-dump” schemes targeting the stocks of two or more penny stocks, microcap stocks, etc.), based on their analysis of previously identified behavior of artificial price manipulators. For example, there are approximately 11,000 microcap stocks available for trading over national exchanges and/or available on over-the-counter (OTC) markets, and there are over 60 million possible combinations to choose any two microcap stocks. During a review of 8,082,705 microcap stock purchases between January 2017 to June 2021, the Inventors discovered that microcap stocks were co-traded by an individual investor only a small percentage of the time. In other words, an individual investor purchased two or more different microcap stocks during a desired sliding time period 90 days. Consequently, the Inventors have discovered that the detection rate of artificial price manipulation may be significantly improved by analyzing the trading behavior of co-traded securities, instead of analyzing the trading behavior of single securities, and then further identifying potential factors which may have contributed to legal and/or natural changes to the price of the security.

According to at least one example embodiment, potential artificial market manipulation may be detected by analyzing co-trading time series data of groups of two or more securities (referred to herein as “co-pairs” or “co-tuples”, etc.) of a plurality of trading accounts over desired sliding time windows to identify and/or determine co-traded securities for further analysis for suspicious trading activity, fraudulent trading activity, and/or illegal trading activity. The trading transaction activity of the identified co-traded securities may be further analyzed to detect and/or determine changepoints in the trading behavior of the identified co-traded securities to determine instances of increased trading activity over a baseline and/or normal level of trading activity which can indicate suspicious trading activity and/or potentially artificial market manipulative activity. Changepoints are defined as an abrupt disruption in the probability distribution of time series data which may represent major transitions between different states, sequences, and/or segments in the time series data. For example, a set of time series data may include a plurality of segments wherein the data values within each segment have a similar mean, standard deviation, and/or linear trend, and the changepoints are the datapoints where there is a significant change between the preceding segment and the next segment's mean, standard deviation, and/or linear trend values, etc.

Then, according to at least one example embodiment, information associated with the suspicious trading activity, such as information regarding the user accounts involved in the suspicious trades, the transaction data itself, etc., may be forwarded to fraud investigators, law enforcement, and/or security regulators, etc., for further investigation and/or analysis. Additionally, according to some example embodiments, a search and/or investigation (e.g., an automated search and/or investigation) may be performed for external factors associated with the identified securities which may have caused and/or impacted the increased suspicious trading activity, etc., during the relevant time period(s) corresponding to the determined changepoints, such as company press releases affecting the stock price, regulatory changes affecting the relevant industry, etc., to further reduce potential false positive identifications, etc.

Moreover, at least one example embodiment provides methods, systems, devices, and/or non-transitory computer readable media for determining potential victims and/or perpetrators of artificial price manipulation based on the detection of suspicious trading activity and/or potential artificial market manipulation. Additionally, according to at least some example embodiments, the detection of potential artificial price manipulation behavior may be performed on historical data stored on the online trading platform and/or may be performed in real-time and/or near real-time on incoming trading transactions processed by the online trading platform, etc., but the example embodiments are not limited thereto. Further, according to some example embodiments, the detection of potential artificial price manipulation behavior on an “online” and/or streaming basis, wherein the analysis is performed on new data as the new data arrives, without re-calculating previous analysis, etc.

While the various example embodiments of the present disclosure are discussed in connection with an online brokerage platform and the trading of penny stocks and/or microcap stocks (e.g., stocks for companies that have a market capitalization between $50 million and $300 million) for the sake of clarity and convenience, the example embodiments are not limited thereto, and one of ordinary skill in the art would recognize the example embodiments may be applicable to other types of securities (e.g., bonds, commodities, options, etc.), other size categories of securities (e.g., mid-cap, large-cap, etc.), other transaction platforms (e.g., stock exchanges, commodities exchanges, etc.), and/or other types of transactions (e.g., short sales, margin purchases, futures contracts, etc.), etc. Additionally, the example embodiments are not limited to the detection of potentially fraudulent activity in securities trading activity and may be applied to other technological fields, such as the detection of fraudulent and/or potentially fraudulent computer network activity (e.g., hacking and/or phishing attacks on user computer accounts, etc.), the detection of fraudulent and/or potentially fraudulent identity theft activity, etc., and may provide similar benefits of reducing false positive rates, etc.

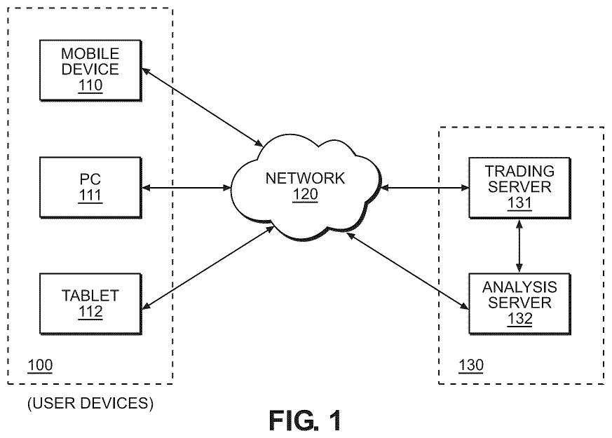

FIG. 1 illustrates a system associated with an online trading platform according to at least one example embodiment. As shown in FIG. 1, the online trading platform system includes a plurality of user devices 100 including a mobile device 110, a personal computer 111, and a tablet 112, etc., a network 120, and at least one server 130 associated with the online trading platform, but the example embodiments are not limited thereto, and the example embodiments may include a greater or lesser number of constituent elements. According to at least one example embodiment, the server 130 may host and/or provide functionality of at least a portion of a desired brokerage firm and/or security exchange, etc., and may include a trading server 131 for receiving security transaction requests (e.g., buy orders, sell orders, security research requests, etc.) from at least one user of the online trading platform, and an analysis server 132 for performing analysis on records of securities transaction of desired sets of securities and/or users to detect manipulation due to fraud, etc. According to some example embodiments, the trading server 131 and the analysis server 132 may be implemented in a single server, or one or more of the trading server 131 and/or the analysis server 132 may be implemented as a plurality of servers, etc. Additionally, each of the plurality of user devices 100 may allow a respective user to access the online trading platform via the at least one server 130. For example, one or more of the plurality of user devices 100 may have software application(s) (e.g., apps, programs, code, computer readable instructions, etc.) installed and/or may execute software application(s) corresponding to the online trading platform (e.g., the online trading platform client application, etc.), and/or one or more of the plurality of user devices 100 may have installed and/or may execute a web browser application which allows a corresponding user of the user device to access a website for the online trading platform, execute trades on the online trading platform, etc., but the example embodiments are not limited thereto. According to some example embodiments, the user devices 100 may include computing devices, such as a personal computer (PC), a laptop, a server, a database system, a smartphone, a tablet, any other smart devices, a wearable device, an Internet-of-Things (IoT) device, a virtual reality (VR) and/or augmented reality (AR) device, a virtual assistant device, a Personal Digital Assistant (PDA), etc., but are not limited thereto. Additionally, the plurality of user devices 100 may further include computing devices which may be indirectly accessed by a user of the online trading platform to place securities transactions on behalf of the user, such as the computer of a stockbroker who, for example, receives a phone trade order from the user, etc. Further, the example embodiments are not limited thereto, and for example, the system may include a plurality of additional servers associated with (and/or hosting, implementing, storing transaction data, etc.) the online trading platform, the system may include additional servers corresponding to other brokerage firms and/or security exchanges, etc., the system may include less than three user devices, the system may include greater than three user devices, etc.

The plurality of user devices 100 and the server 130 may be connected over the network 120, and the network 120 may correspond to a wireless network, such as a cellular wireless access network (e.g., a 3G wireless access network, a 4G-Long Term Evolution (LTE) network, a 5G-New Radio (e.g., 5G) wireless network, a WiFi network, a satellite network, etc.) and/or a wired network (e.g., a fiber network, a cable network, a PTSN, etc.). The server 130 may connect to other servers (not shown), over a wired and/or wireless network, and each of the user devices 110, 111, and/or 112 may connect to other user devices over a wired and/or wireless network. The network 120 may refer to the Internet, an intranet, a wide area network, etc.

While certain components of a system associated with an online trading platform are shown in FIG. 1, the example embodiments are not limited thereto, and the system may include components other than that shown in FIG. 1, which are desired, necessary, and/or beneficial for operation of the underlying networks within the system, such as base stations, access points, switches, routers, nodes, servers, gateways, etc.

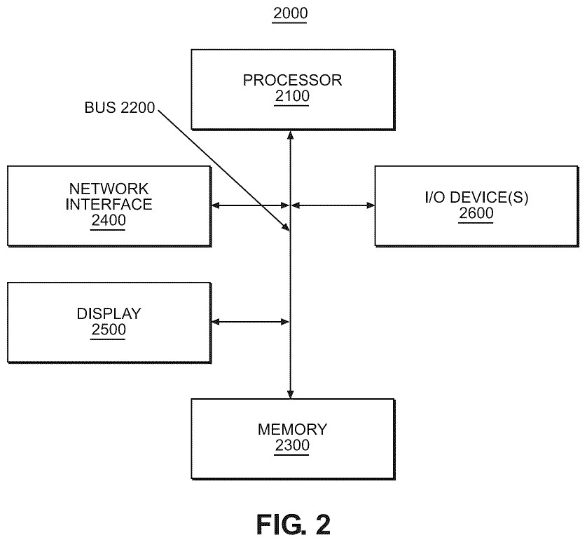

FIG. 2 illustrates a block diagram of an example computing device of the online trading platform according to at least one example embodiment. The computing device 2000 of FIG. 2 may correspond to the server 130, the trading server 131, the analysis server 132, and/or one or more of the plurality of user devices 100 of FIG. 1, but the example embodiments are not limited thereto.

Referring to FIG. 2, a computing device 2000 may include processing circuitry, such as the at least one processor 2100, at least one communication bus 2200, a memory 2300, at least one network interface 2400, and/or at least one input/output (I/O) device 2500 (e.g., a keyboard, a touchscreen, a mouse, a microphone, a camera, a speaker, etc.), etc., but the example embodiments are not limited thereto. For example, the computing device 2000 may further include a display panel 2500, such as a monitor, a touchscreen, etc. The memory 2300 may include various special purpose program code including computer executable instructions which may cause the computing device 2000 to perform the one or more of the methods of the example embodiments, including but not limited to computer executable instructions related to an online trading platform, a trained neural network for performing the co-trading changepoint detection, a security transaction database associated with the online trading platform and/or the trained neural network, etc.

In at least one example embodiment, the processing circuitry may include at least one processor (and/or processor cores, distributed processors, networked processors, etc.), such as the at least one processor 2100, which may be configured to control one or more elements of the computing device 2000, and thereby cause the computing device 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire computing device 2000. Once the special purpose program instructions are loaded into, (e.g., the at least one processor 2100, etc.), the at least one processor 2100 executes the special purpose program instructions, thereby transforming the at least one processor 2100 into a special purpose processor.

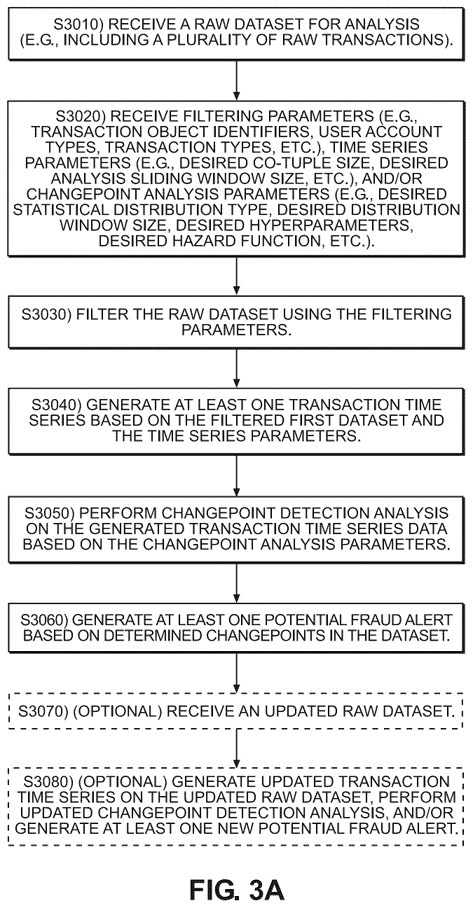

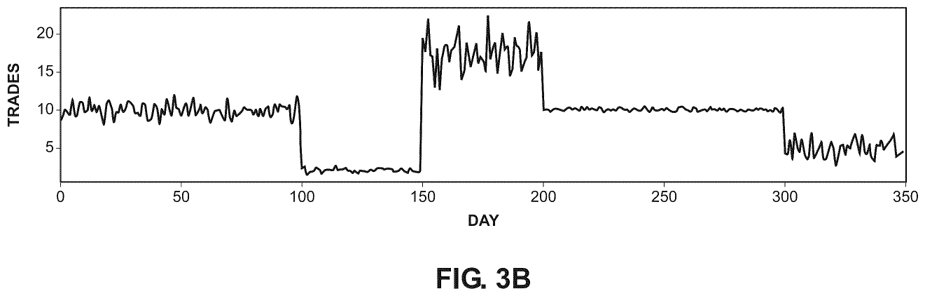

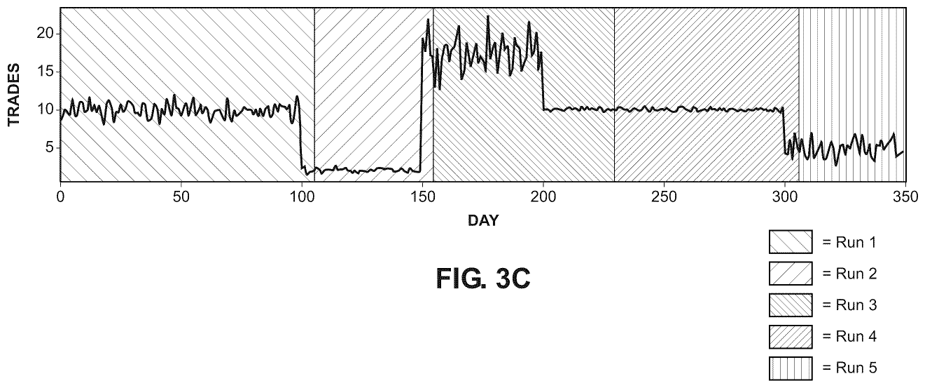

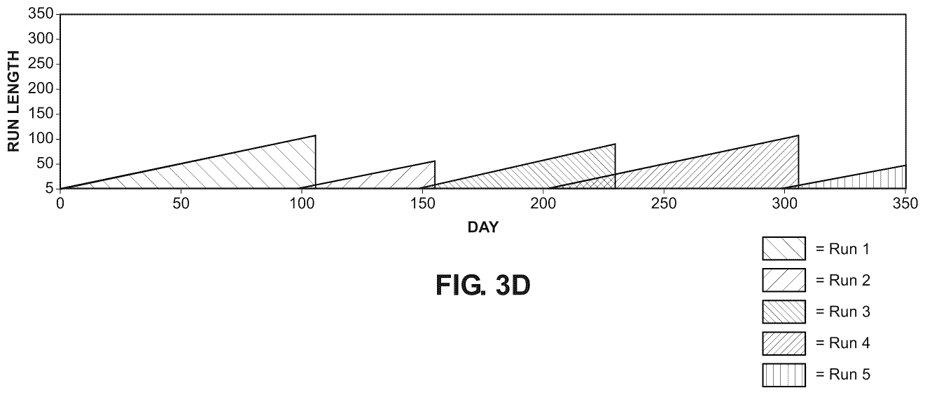

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the online trading platform (e.g., the co-trading changepoint detection service, a database for storing raw security transaction data, trading platform user account information, etc.) and/or the computing device 2000, such as the methods discussed in connection with FIGS. 3A to 6, the at least one network interface 2400, and/or at least one I/O device 2500, etc. Such software elements may be loaded from a non-transitory computer-readable storage medium independent of the memory 2300, using a drive mechanism (not shown) connected to the computing device 2000, or via the at least one network interface 2400, and/or at least one I/O device 2500, etc.

In at least one example embodiment, the at least one communication bus 2200 may enable communication and/or data transmission to be performed between elements of the computing device 2000. The bus 2200 may be implemented using a high-speed serial bus, a parallel bus, and/or any other appropriate communication technology. According to some example embodiments, the computing device 2000 may include a plurality of communication buses (not shown).

The computing device 2000 may be associated with an online trading platform and may operate as, for example, a trading server, a brokerage server, a financial services server (e.g., banking services, loan services, etc.), an analysis server, a web server, a messaging server, a search server, a news server, etc., or any combinations thereof, and may be configured to provide security trading services and/or financial services to at least one user of the online trading platform. Additionally, the computing device 2000 may also provide communication and/or messaging services for the one or more users of the online trading platform which allows users of the online trading platform to contact and/or message one or more other users of the online trading platform via the computing device 2000. For example, the computing device 2000 may also provide an online community (e.g., a forum, a website, a portal, a discussion board, an investment advisor service, a fraud investigation service, a group chat service, a teleconference service, a videoconference service, etc.) wherein users of the online trading platform may transmit messages for employees of the online trading platform, such as brokerage advisors, financial advisors, IT administrators, fraud investigators, etc., security regulators, law enforcement officers, other users of the online trading platform, or a subset of the users of the online trading platform. Moreover, the online trading platform may provide one or more sections and/or areas dedicated to different categories of interest to the users (e.g., security topics, trading tips, financial news, political news, national/world news, etc.).

According to at least one example embodiment, the computing device 2000 may host an online trading platform providing users with the ability to perform securities transactions, e.g., purchases of stocks, sales of stocks, purchase and/or sales of options contracts, obtaining loans for purchasing stocks, etc., but the example embodiments are not limited thereto, and for example, the online trading platform is not limited to stocks, and may include other classes and/or categories of securities, other classes and/or categories of transactions, etc. The online trading platform may perform co-trading changepoint detection to detect potential artificial market manipulation in the price of co-traded securities, by generating at least one transaction time series for one or more identified co-tuples of securities from at least one raw trading transaction dataset stored on the online trading platform, etc., performing changepoint detection analysis on the generated at least one transaction time series, and then generating at least one potential fraud alert based on the determined changepoints for the identified co-tuples of securities, but the example embodiments are not limited thereto. The methods for performing the detection of potential artificial market manipulation according to some example embodiments will be discussed in further detail in connection with FIGS. 3A to 6.

While FIG. 2 depicts an example embodiment of a computing device 2000, the computing device 2000 is not limited thereto, and may include additional and/or alternative architectures that may be suitable for the purposes demonstrated. For example, the functionality of the computing device 2000 may be divided among a plurality of physical, logical, and/or virtual server and/or computing devices, network elements, etc., but the example embodiments are not limited thereto.

FIG. 3A illustrates an example method for performing co-trading changepoint detection according to at least one example embodiment. FIG. 3B is an example co-trading graph illustrating example transactions involving a selected co-tuple group. FIGS. 3C and 3D are two example graphs illustrating detected changepoints in the co-trading transactions of a selected co-tuple group.

Referring now to FIG. 3A, in at least one example embodiment, in operation S3010, a server, such as the analysis server 132 of FIG. 1, may receive and/or obtain at least one raw dataset for analysis, but is not limited thereto. In at least one example embodiment, the analysis server 132 may receive the raw dataset from a trading server, such as the trading server 131 of FIG. 1, and/or other transaction server(s) from at least one online trading platform, a brokerage firm, a stock exchange, a banking institution, and/or a governmental regulatory agency (e.g., the Financial Industry Regulatory Authority (FINRA), the U.S. Securities and Exchange Commission (SEC), etc.), but the example embodiments are not limited thereto. The raw dataset may include information and/or data associated with a plurality of raw securities transactions, such as a transaction identifier, a transaction object identifier (e.g., stock ticker, etc.), a transaction object type (e.g., microcap stock, small-cap stock, midcap stock, large-cap stock, international microcap/small-cap/midcap/large-cap stock, mutual fund shares, exchange traded fund (ETF) shares, etc.), a transaction type (e.g., stock purchase, stock sale, options contract purchase, options contract sale, etc.), transaction price amount (e.g., price of stock purchase, etc.), transaction share amount (e.g., number of stock shares being transacted, etc.), transaction user account information, and/or the time and date of the transaction (e.g., transaction timestamp information, etc.), etc., but the example embodiments are not limited thereto. According to some example embodiments, the transaction user account information may include purchaser user account information and/or seller user account information, such as the online trading platform user account identifier associated with the purchaser/seller, the real name of the purchaser/seller, the contact information of the purchaser/seller (e.g., mailing address, phone number, email address, etc.), the banking account information associated with the purchaser/seller, the user account type associated with the purchaser/seller (e.g., is the user account a personal account, a retirement account, an institution account, etc.), but the example embodiments are not limited thereto. The raw dataset may include raw transaction data over a desired time range (e.g., one fiscal quarter, a fiscal year, a plurality of years, etc.), but is not limited thereto. Additionally, according to some example embodiments, the analysis server 132 may receive and/or obtain new raw transaction data from the trading server 131 at desired time intervals, such as on a monthly basis, weekly basis, daily basis, an hourly basis, a per-minute basis, etc.), and/or on a transaction basis, such as every hundred transactions, every ten transactions, every transaction, etc. For example, the analysis server 132 may receive the new raw transaction data on a real-time basis from the trading server 131, or on a near real-time basis, but the example embodiments are not limited thereto. Additionally, according to some example embodiments, the trading server 131 and the analysis server 132 may be combined into a single server, etc.

In operation S3020, the analysis server 132 may receive filtering parameters, time series parameters, and/or changepoint analysis parameters from the trading server 131, an administrator of the online trading platform, a user device 100, etc., but the example embodiments are not limited thereto. According to at least one example embodiment, the filtering parameters includes parameters to use to filter the raw dataset, such as a list of desired transaction object identifiers (e.g., a list of desired stock tickers to analyze, etc.), one or more desired transaction object types (e.g., all transactions involving microcap stock, all transactions involving penny stocks, etc.), one or more desired user account types (e.g., transactions involving personal trading accounts, etc.), and/or one or more desired transaction types (e.g., stock purchases, stock sales, option call contracts, option put contracts, etc.), etc., but the example embodiments are not limited thereto. According to at least one example embodiment, the time series parameters includes parameters to apply during the generation of the transaction time-series, such as a desired co-tuple size (e.g., the number of microcap stocks in a co-trading group to analyze, etc.), and/or a desired analysis sliding time window size (e.g., 1 year, 6 months, 120 days, 90 days, 1 week, 1 day, 1 hour, 1 minute, etc.), etc., but the example embodiments are not limited thereto. According to at least one example embodiment, the changepoint analysis parameters includes parameters to apply during the changepoint detection analysis, and may include a desired statistical distribution type (e.g., a gaussian distribution, a Poisson distribution, a chi-squared distribution, etc.), a desired set of hyperparameters (e.g., mean, standard deviation, rate, etc.), a desired distribution window size for the changepoint detection, and/or a desired hazard function corresponding to the desired set of hyperparameters, etc., but the example embodiments are not limited thereto. According to some example embodiments, the changepoint analysis parameters may further include a desired trading baseline level (e.g., a threshold level of trading activity which is considered normal, etc.) and/or a desired changepoint run-length percentage (e.g., a threshold run-length level which is considered normal, etc.), but the example embodiments are not limited thereto.

Next, in operation S3030, the analysis server 132 may filter the raw dataset using the filtering parameters and thereby generate a filtered first dataset, etc., but is not limited thereto. For example, if the filtering parameters included all microcap stocks as the desired transaction object type, all personal trading accounts as the desired user account type, and stock purchases as the desired transaction type, the analysis server 132 may filter the raw dataset for transaction data involving microcap stock purchase transactions performed by personal trading accounts, etc., but the example embodiments are not limited thereto.

In operation S3040, the analysis server 132 may generate at least one transaction time series based on the filtered first dataset and the received time series parameters. Assuming that the received time series parameters set the desired co-tuple size as 2, and the desired sliding analysis time window size to be 1 week, the analysis server 132 may generate the transaction time series by analyzing the plurality of transactions included in the filtered first dataset and determining time series datapoints from the filtered first dataset using the time series parameters, or in other words, an ordered sequence of datapoints corresponding to the relevant transactions involving co-tuples of the desired size in the filtered first dataset. For example, the analysis server 132 may determine whether different pairs of microcap stocks were traded by a single trading account within a week of each other, etc., but the example embodiments are not limited thereto, and other time series parameters may be used, etc. Each determined instance of a co-trade may be set as a datapoint for the time series for the co-tuple combination.

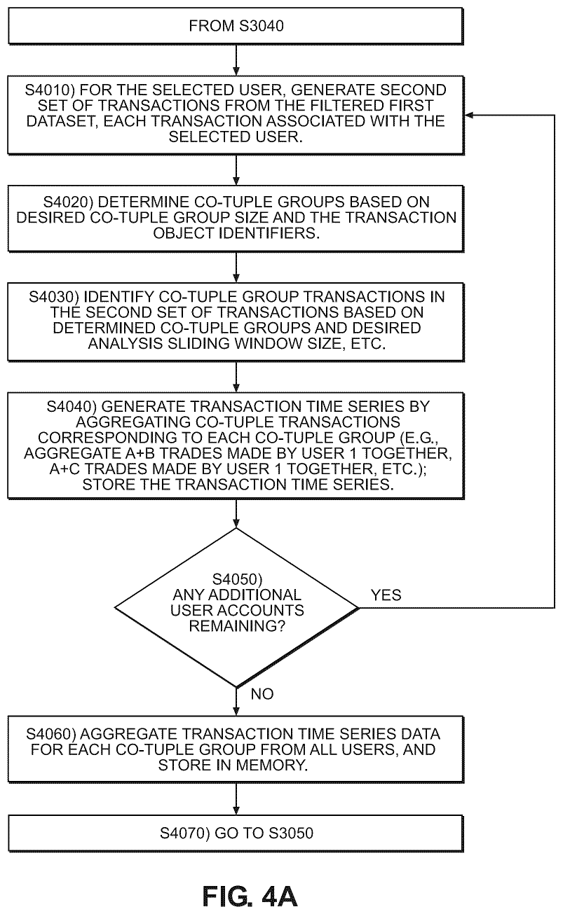

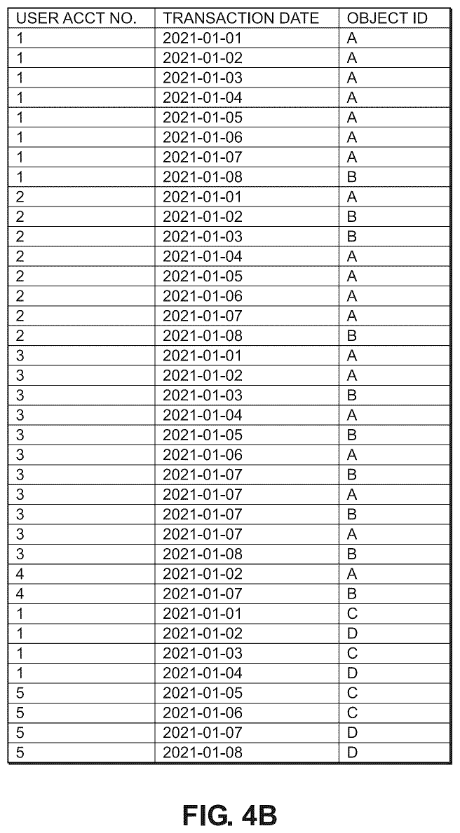

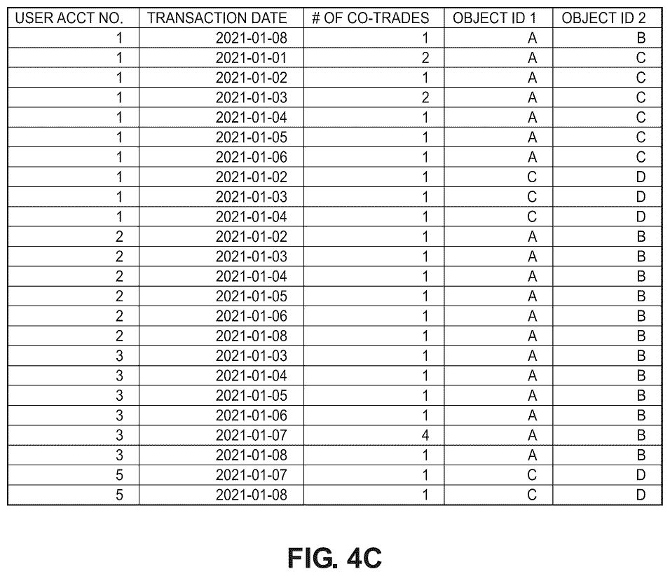

For example, assuming the first dataset includes purchase transactions involving Microcap A, Microcap B, and Microcap C, a first co-tuple combination may be set as Microcap A and Microcap B, a second co-tuple combination may be set as Microcap A and Microcap C, a third co-tuple combination may be set as Microcap B and Microcap C, and a co-trade refers to an instance where a single user performs the desired transaction type of any of the desired co-tuple combinations during any sliding time window, e.g., user 1 purchases Microcap A stock and Microcap B stock within a first 1 week time period, user 2 purchases Microcap A stock and Microcap C stock within a second 1 week time period, and/or user 3 purchases Microcap B stock and Microcap C stock within the second 1 week time period, etc., but the example embodiments are not limited thereto. According to some example embodiments, each transaction time series datapoint may include the transaction object identifiers (e.g., stock tickers, etc.) involved in the co-trade, the date and/or time of the co-trade (e.g., the date when the last transaction of the co-trade pair occurred, the date when the first transaction of the co-trade pair occurred, etc.), the user account information of the user(s) performing the co-trade, the number of co-trades performed on that date, etc., but the example embodiments are not limited thereto. The analysis server 132 may then aggregate each datapoint into a time series for each co-tuple combination (e.g., aggregate all datapoints involving Microcap A and Microcap B together, etc.) made by each individual user, and for example, the analysis server 132 may aggregate all datapoints for a particular user account together, aggregate all datapoints for a particular date together, etc. As another example, the analysis server 132, for each user account, may generate a first time series for Microcap A and Microcap B co-trades, generate a second time series for Microcap A and Microcap C co-trades, generate a third time series for Microcap B and Microcap C co-trades, and then the analysis server 132 may aggregate all of the first time series made by all of the users, aggregate all of the second time series made by all of the users, aggregate all of the third time series made by all of the users, etc., but the example embodiments are not limited thereto. The generation of the transaction time series will be discussed in further detail in connection with FIG. 4A.

In operation S3050, the analysis server 132 may perform changepoint detection (CPD) analysis on each of the generated transaction time series data based on the received changepoint analysis parameters. The analysis server 132 may perform the changepoint detection analysis on the previously generated transaction time series data and may determine changepoints, or abrupt changes in the distribution of the datapoints, of the generated transaction time series. More specifically, for each datapoint in a transaction time series for a desired co-tuple combination of securities, the analysis server 132 determines the probability that the current datapoint of the transaction time series (e.g., a current and/or new instance of the desired co-trading activity of the desired co-tuple combination of securities) would occur given the previous history of the generated transaction time series in view of the received changepoint analysis parameters, such as the received desired statistical distribution type (e.g., Gaussian distribution, etc.) the received desired distribution window size (e.g., 1 week, 1 month, 1 fiscal quarter, 1 year, etc.), the received hyperparameters corresponding to the desired statistical distribution type (e.g., mean and standard deviation, etc.), the received hazard function (e.g., 250, etc.), and/or the current run length (e.g., the number of datapoints since the last detected changepoint), etc., but the example embodiments are not limited thereto, and for example, other values for the desired distribution window size, hyperparameters, and/or received hazard function, etc., may be used. In other words, the analysis server 132 will determine the probability that the current datapoint (e.g., datapoint A) is natural co-trading activity (e.g., a statistically normal level of co-trading activity, etc.) or an abnormal co-trading activity (e.g., a statistically suspicious and/or potentially fraudulent level of co-trading activity, etc.) in comparison to all of the previous trades of the desired co-tuple combination since the previously detected changepoint, etc., but the example embodiments are not limited thereto.

According to some example embodiments, the analysis server 132 may perform Bayesian changepoint detection (e.g., Bayesian offline changepoint detection and/or Bayesian online changepoint detection) on the generated transaction time series data, but the example embodiments are not limited thereto, and other changepoint detection algorithms may be used, such as nonparametric change point detection, energy change point detection, at most one change changepoint detection, kernel change-point analysis, prophet changepoint detection, pruned exact linear time, wild binary segmentation, etc.. Further, according to some example embodiments, a naïve changepoint detection algorithm may be used as well, such as defining desired change in trading activity thresholds (e.g., determining that a changepoint has occurred if the observed trading activity for the co-tuple group for a current time period is +/−20% the trading activity for the co-tuple group for a previous time period, that the observed trading activity is one or two standard deviations away from the trading activity for the co-tuple group from a median trading activity for the co-tuple group, etc.), but the example embodiments are not limited thereto.

Turning now to FIGS. 3B to 3D, FIG. 3B is an example co-trading graph illustrating example trading transactions (e.g., co-trading transactions, co-trading activity, etc.) involving a selected co-tuple combination (e.g., Microcap A and Microcap B, etc.), wherein the graph represents the number of co-trades involving the selected co-tuple combination occurring per day. FIG. 3C is an example graph illustrating the transaction time series data corresponding to the co-trading graph of FIG. 3B and detected changepoints in the transaction time series data, and FIG. 3D is an example graph illustrating the run lengths between determined changepoints corresponding to the detected changepoints in the graph of FIG. 3C. As shown in FIG. 3C, while there may be fluctuations in the level of co-trading activity of the selected co-tuple combination between day 0 and day 100 (e.g., “Run 1”), such as increases and/or decreases in co-trading activity in FIG. 3B, the level of fluctuations is within a desired statistical probability range corresponding to the desired statistical distribution type and the desired distribution window size and therefore is considered to be statistically “natural” and/or “normal” co-trading activity for the co-tuple combination, and therefore no changepoint is detected between day 0 and day 100, however, the example embodiments are not limited thereto. Additionally, as seen in FIG. 3D, the run length counter for the current run is increased by 1 for each day between day 0 and day 100 due to the absence of changepoints detected between day 0 and approximately day 100.

Further, as seen in FIGS. 3C and 3D, because the transition between days 100 and 101 was determined to be a changepoint, the analysis server 132 will start a new run (e.g., “Run 2”) by resetting the current run length to zero, and for the next datapoint in the transaction time series (e.g., the datapoint corresponding to day 101), the analysis server 132 will determine the probability that the next datapoint fits with the co-trading activity history for the current run starting from datapoint corresponding to day 101, etc., but the example embodiments are not limited thereto. As shown in FIGS. 3B to 3D, the analysis server 132 determines that the co-trading activity level between days 101 and 155 are statistically likely to be “natural” and/or “normal” trading, and therefore no changepoint is detected between days 101 and 155, etc. However, as shown in FIGS. 3B and 3C, the analysis server 132 detects a second changepoint between day 155 and day 156 based on the change in trading activity between days 101 to 150 and the trading activity on day 156, etc. Further, as shown in FIG. 3C, while the amount and/or magnitude of fluctuation and/or variation caused by a change in trading activity for selected co-tuple combination in the graph between day 155 and day 200 (e.g., “Run 3”) is greater than the amount and/or magnitude of fluctuation and/or variation in the graph between days 0 and day 100 of Run 1, or the amount and/or magnitude of fluctuation and/or variation in the graph between day 101 and day 150 of Run 2, the analysis server 132 determines that the co-trading activity between days 156 to 200 of Run 3 are not statistically abnormal using the CPD algorithm.

However, as seen in the transition between day 200 to day 201 in FIGS. 3B and 3C, even though the change in the level of co-trading activity for the co-tuple group on starting on day 201 to day 300 is smaller than the change in the level of co-trading activity between days 1 to 100, and days 150 to 200, the analysis server 132 detects a changepoint between day 225 and day 226 due to the calculated probability of the run length being greater than 70 days being determined to be statistically unlikely, as shown in FIG. 3C.

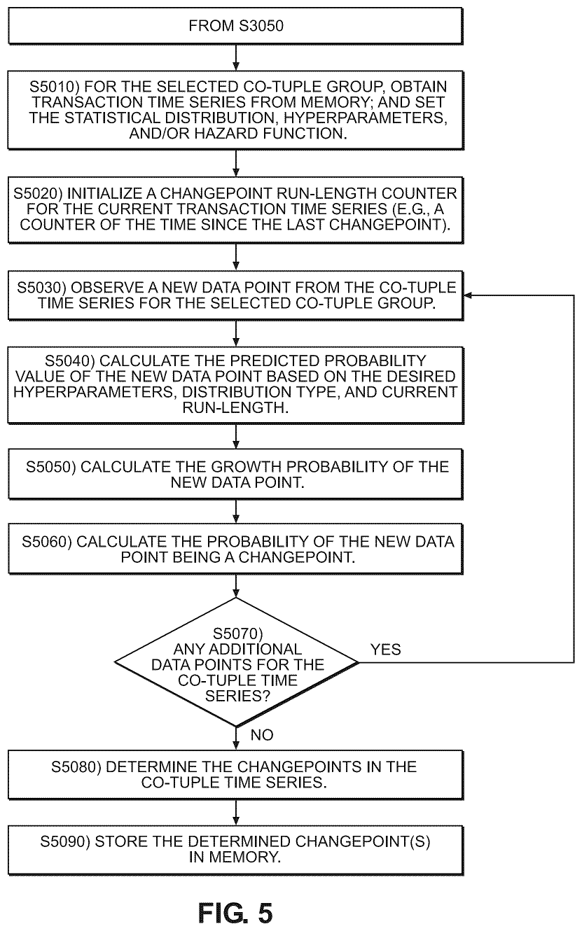

Additionally, as seen in FIG. 3D, the analysis server 132 may determine that there is an overlap between two or more runs, as seen in the transition period between Run 3 and Run 4, e.g., days 210 to 225, wherein the start of a current run may occur before the end of a previous run, etc., but the example embodiments are not limited thereto. This overlap may occur due to the analysis server 132 determining that a changepoint occurred (e.g., at day 210, etc.), but the analysis server 132 determining the statistical probability of the run length of the previous run (e.g., Run 3) not being determined to be statistically unlikely, but the example embodiments are not limited thereto. Detailed discussion of the methods for performing the changepoint detection will be made in connection with FIG. 5.

In at least one example embodiment, all of the datapoints in an entire distribution run may be determined to be “abnormal” in comparison to the datapoints of previous and/or future datapoints, and all of the datapoints in the abnormal distribution run may be determined to be changepoints (e.g., suspicious, abnormal, and/or flagged for further review, etc.), but the example embodiments are not limited thereto. Moreover, the trading transaction changepoint detection analysis is specifically tailored to the previous trading activity level (e.g., trading history) of the co-tuple group and/or combination (e.g., Microcap A and Microcap B, or Microcap B and Microcap C), which thereby further reduces the possibility that a false positive potentially artificial market manipulation is detected, by not comparing the trading activity level of the co-tuple combination against the trading activity level of securities which may not share the same trading activity levels as the selected co-tuple combination and/or may be influenced by external factors that are not common with the selected co-tuple combination.

Additionally, for each datapoint determined to be a changepoint for the transaction time series, the analysis server 132 stores the datapoints in its database, including the information associated with the changepoint datapoint(s), such as the user account information associated with the changepoint datapoint, the transaction object identifiers involved in the co-trade, the dates and/or times of the co-trade(s), etc., but the example embodiments are not limited thereto. Additionally, according to some example embodiments, the analysis server 132 may also store information corresponding to a desired number of datapoints before and/or after the determined changepoint as contextual information, e.g., 5 datapoints before and 5 datapoints after for further analysis and/or comparison purposes, but the example embodiments are not limited thereto. Moreover, according to some example embodiments, it is possible for the tail end of one distribution run to overlap with the start of the next distribution run, etc.

In operation S3060, the analysis server 132 may generate at least one fraud alert based on the datapoints determined to be changepoints stored in the database. As an example, the analysis server 132 may generate at least one fraud alert for Microcap A and Microcap B co-trades by including the information associated with the changepoint datapoint(s) for the Microcap A and Microcap B transaction time series, such as the user account information associated with the changepoint datapoint, the transaction object identifiers involved in the changepoint datapoint, the date and/or time of the changepoint datapoint, etc., but the example embodiments are not limited thereto. Additionally, the analysis server 132 may further include the information associated with the additional datapoint(s) before and/or after each changepoint datapoint in the at least one fraud alert, but the example embodiments are not limited thereto. The analysis server 132 may then transmit the at least one fraud alert to fraud investigators associated with the online trading platform, law enforcement, and/or security regulators, etc., for further investigation and/or analysis of the potentially fraudulent trading activity. Additionally, the analysis server 132 may transmit messages to the users associated with the potentially fraudulent trading activity to inform the users that they may have been victims of a pump-and-dump scheme, etc., to send educational information to the users to inform them on how to avoid being victims of pump-and-dump schemes, and/or to request further information to assist in the investigation of the potentially fraudulent trading activity, such as questions regarding their motivations for making the trades in question, how they became aware of the securities in question, where they obtained information regarding the securities in question (e.g., social media accounts, websites, forums, etc.), but the example embodiments are not limited thereto.

According to some example embodiments, the analysis server 132 may also automatically search for external information associated with the co-tuple securities on or around the dates and/or times of the potentially fraudulent co-trading activity, such as media statements, reports, and/or press releases made by the microcap companies in question, SEC filings by the microcap companies, news stories regarding the microcap companies, social media posts from verified accounts for the microcap companies and/or corporate officers of the microcap companies, etc., which may provide a “natural” explanation for the abrupt change and/or deviation in trading activity for the co-tuple securities in question, but the example embodiments are not limited thereto. Additionally, the analysis server 132 may include the external information in the fraud alert messages transmitted to investigators, etc., but the example embodiments are not limited thereto.

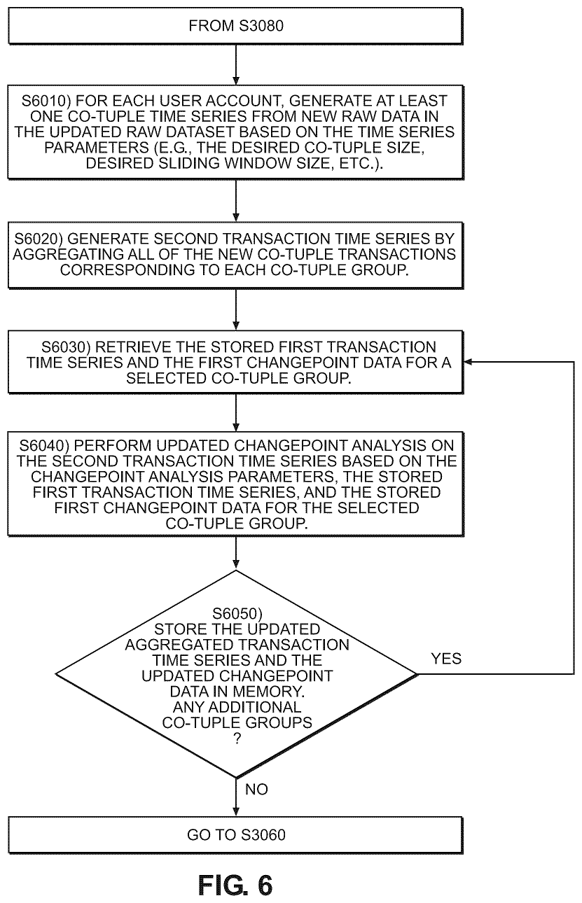

Next, in optional operation S3070, the analysis server 132 may receive an updated raw dataset including at least one new raw transaction from the trading server 131, but the example embodiments are not limited thereto. For example, the updated raw dataset may include a “batch update” including a plurality of new trading transactions which may be transmitted by the trading server 131 to the analysis server 132 at desired periods of time, e.g., every hour, every day, every week, etc., but the example embodiments are not limited thereto. Additionally, and/or alternatively, the trading server 131 may transmit the new raw transactions to the analysis server 132 as they occur, or in other words, in real-time, or within a desired delay time period, e.g., in near real-time, etc. In optional operation S3080, the analysis server 132 may generate updated transaction time series based on the previously generated transaction time series and the updated raw dataset, similar to operation S3040 of FIG. 3A and/or similar to operations S4010 to S4060 of FIG. 4A, but the example embodiments are not limited thereto. Further, the analysis server 132 may perform updated changepoint detection analysis (e.g., “online analysis”) on the updated transaction time series based on the previously performed changepoint analysis and the received changepoint analysis parameters, but the example embodiments are not limited thereto. The method for performing the updated changepoint detection analysis will be discussed in further detail in connection with FIG. 6. Moreover, the analysis server 132 may generate at least one new and/or additional potential fraud alert based on the results of the updated changepoint detection analysis, similar to operation S3060 of FIG. 3A, but the example embodiments are not limited thereto.

FIG. 4A illustrates an example method for performing time-series generation for each individual user account included in a filtered transaction dataset according to at least one example embodiment. FIG. 4B illustrates an example first raw dataset including a plurality of transactions according to at least one example embodiment. FIG. 4C illustrates an example co-trading transaction time series associated with a user account according to at least one example embodiment.

Referring now to FIG. 4A, according to at least one example embodiment, in operation S4010, following the filtering of a raw transaction dataset (e.g., as discussed in connection with operation S3030 of FIG. 3A), the analysis server 132 may generate a second set of transactions associated with a selected user account from the filtered first transaction dataset, by filtering the filtered first transaction dataset to exclude transactions which are not associated with and/or correspond to the selected user account. More specifically, the analysis server 132 may filter the first transaction dataset (e.g., shown in FIG. 4B) using a unique user identifier (ID) associated with the selected user account to identify and/or select the trading transactions associated with the selected user account, etc., but the example embodiments are not limited thereto. In operation S4020, the analysis server 132 may determine co-tuple groups based on the received desired co-tuple group size and/or the transaction object identifiers, but the example embodiments are not limited thereto. For example, if the desired co-tuple group size is two, the analysis server 132 may determine all possible co-tuple combinations of transaction object identifiers which are sets of two distinct transaction object identifiers (e.g., identify all unique groups of 2 microcap stock tickers, etc.). For example, FIG. 4B represents example raw transactions included in a first filtered raw dataset, but the example embodiments are not limited thereto. Assuming that the universe of transaction object identifiers included in the first dataset consists of transaction object identifiers “A”, “B”, “C”, and “D”, and the desired co-tuple group size is two, the entire set of co-tuple group combinations is A and B, A and C, B and C, B and D, and C and D. However, the example embodiments are not limited thereto, and the first dataset may include a greater or lesser number of transactions, unique transaction object identifiers, and/or user accounts, etc., and/or the co-tuple group size is greater than two, etc.

In operation S4030, the analysis server 132 may identify all co-tuple group transactions associated with each identified co-tuple combination for the selected user account in the second set of transactions based on the desired analysis sliding window size. Assuming that the desired analysis sliding window size is 4 days and the desired co-tuple group size is still two, the analysis server 132 will identify co-trades in the second dataset wherein pairs of transactions involving both members of a co-tuple combination occurs within any sliding and/or rolling 4 day period. For example, as shown in FIG. 4B, user ID “1” purchased stock in company “A” on “2021-01-04” and purchased stock in company “B” 4 days later on “2021-01-08”, and thus this pair of transactions would be considered as a co-tuple group transaction (e.g., a co-trade, etc.). Additionally, user ID “1” purchased stock in company “A” on “2021-01-5,” and because this purchase occurred within 4 days of the purchase of “B” stock on “2021-01-08” this is counted as a separate co-trade as well, etc. Moreover, according to some example embodiments, the analysis server 132 may assign a transaction date to a “co-trade” as the date of the later transaction of the co-tuple combination, e.g., “2021-01-08” for both of the above discussed examples, but the example embodiments are not limited thereto, and other dates may be assigned for the co-trade, such as the date of the first transaction of the co-trade, etc.

Next, in operation S4040, the analysis server 132 generates at least one transaction time series for each identified co-tuple combination (e.g., co-tuple group, etc.) for the selected user account by aggregating all of the co-trade transactions performed by the selected user account involving the selected co-tuple combination, etc., but the example embodiments are not limited thereto. For example, as shown in FIG. 4C, an example transaction time series for a user ID “1” may include the transaction object IDs for the co-tuple combination, the transaction date for the co-trades of the co-tuple combination, the number of co-trades of the co-tuple combination performed on the transaction date by the user ID, etc., but the example embodiments are not limited thereto, and for example may include additional information such as the transaction identifier for each transaction (e.g., stock purchase transaction ID, etc.), the timestamp for each individual transaction of a co-trade (e.g., the timestamp information for the transaction involving “A”, the timestamp information for the transaction involving “B”, etc.), but the example embodiments are not limited thereto. The analysis server 132 then stores the generated transaction time series associated with the selected user account into memory.

In operation S4050, the analysis server 132 determines whether there is at least one additional user account for which at least one transaction time series is to be generated. If the analysis server 132 determines that there is at least one additional user account, then the analysis server 132 returns to operation S4010. If not, in operation S4060, the analysis server 132 may then aggregate each time series for each co-tuple combination (e.g., aggregate all datapoints involving Microcap A and Microcap B together, etc.) made by all of the users, but the example embodiments are not limited thereto. In operation S4070, the analysis server returns to operation S3050 of FIG. 3A.

FIG. 5 illustrates an example method for performing “offline” changepoint analysis for an individual co-tuple combination according to at least one example embodiment.

Referring now to FIG. 5, according to at least one example embodiment, in operation S5010, for a selected co-tuple combination (e.g., co-tuple group, etc.), the analysis server 132 obtains the generated transaction time series corresponding to the selected co-tuple combination from memory (e.g., from the database of the analysis server 132 and/or online trading platform 130, etc.), and sets, obtains, and/or determines the desired statistical distribution type, desired hyperparameters corresponding to the determined statistical distribution type, and/or the desired hazard function that is appropriate for the transaction time series, etc., but the example embodiments are not limited thereto. As an example, the desired statistical distribution may be a Gaussian distribution with desired hyperparameters set as a mean of 0.0 and standard deviation of 1.0, and/or a desired hazard function value as equal to or larger than the sliding window size, etc., but the example embodiments are not limited thereto. More specifically, the analysis server 132 may set the statistical distribution, hyperparameters (e.g., one or more adjustable and/or tunable parameters, e.g., weights, to be applied to the predictive model corresponding to the selected statistical distribution type, and therefore are dependent on the selected statistical distribution type), and/or hazard function for use in determining the changepoints of the transaction time series to be the received changepoint analysis parameters of operation S3020 of FIG. 3A, but the example embodiments are not limited thereto. According to some example embodiments, the hazard function may be a function corresponding to the changepoint probability of a datapoint based on the amount of time passed since the last changepoint occurred. If all datapoints are equally likely to be a changepoint at any time, the hazard function is a constant value for the expected duration of the segment, but the example embodiments are not limited thereto. Moreover, the hazard function may be determined based on experiential data and/or historical data, etc. For the sake of clarity and brevity, the following paragraphs assume that the statistical distribution type is set as a Gaussian distribution, the hyperparameters are set to e.g., a mean of 0.0 and/or a standard deviation of 1.0, etc., and the hazard function is set to, e.g., the sliding window size +1 day, etc., but the example embodiments are not limited thereto, and other distribution types, hyperparameters, and/or hazard functions and/or values may be used.

In operation S5020, the analysis server 132 may initialize a changepoint run-length counter for a current distribution (e.g., a new distribution, a first distribution, etc.), or in other words, set the run-length counter to a zero value. The run-length counter represents the number of transaction time series datapoints analyzed since the last changepoint was detected, and the run-length counter is reset to zero upon the detection of a new changepoint. In operation S5030, the analysis server 132 may observe and/or obtain a new data point (e.g., the next datapoint, the first datapoint, etc.) from the transaction time series corresponding to the selected co-tuple group, and may increment the run-length counter by 1. In operation S5040, the analysis server 132 may calculate a predicted probability value of the new data point based on the desired statistical distribution type, the desired hyperparameters, and/or the value of the current run-length counter, but the example embodiments are not limited thereto. More specifically, the analysis server 132 determines a predictive probability that this new datapoint, which represents the date of the co-trade and the number of co-trades which occurred on that date, would occur given the hyperparameters of the current distribution and the distribution length (represented by the current run-length counter). The analysis server 132 may calculate the predictive probability using the following equation, but is not limited thereto:

πₜ^{(r)=}P(χxₜ|vₜ^{(r)}, χₜ^{(r)}) [Equation 1]

wherein χₜ represents the new datapoint, vₜ^{(r)} represents the hyperparameters, and χₜ^{(r)} represents the set of recent datapoints (e.g., the set of transaction time series datapoints) since the last detected changepoint.

The predictive probability value will be higher the more similar the current data point is to the previously observed datapoints in the set of recent datapoints (e.g., the previous datapoints in the current distribution), and the predictive probability value will be lower if the current data point is dissimilar to the previously observed datapoints in the set of recent datapoints, etc. For example, if the number of co-trades made in the current data point is similar to and/or the same as the observed pattern of number of co-trades over the previously observed datapoints, and/or the number of days between the current data point and observed pattern of number of days between co-trades in the previously observed datapoints is similar and/or the same, then the predictive probability of the current data point will be higher, etc.

In operation S5050, the analysis server 132 may calculate the growth probability of the current data point based on the calculated growth probabilities of each of the previous data points of the current distribution up to the current data point, the result of the calculated predictive probability of the current data point (calculated in operation S5040), and the probability that the hazard function has not occurred. The analysis server 132 may calculate the predictive probability using the following equation, but is not limited thereto:

[symbol]

### [Equation 2]

wherein rₜ represents the current distribution run, and H(rₜ) represents the hazard function.

Additionally, the growth probability of the current data point has higher values if the current data point comes from and/or fits the same underlying probability distribution as the previously observed data points of the current run (e.g., fits the Gaussian distribution formed using the previously observed data points of the current run, is statistically more likely to be follow normal patterns based on the previously observed data, etc.), and has lower values if the current data point does not come from and/or does not fit the same underlying probability distribution as the previously observed data points of the current run (e.g., the data point is statistically less likely to be normal and/or follow normal behavior patterns based on the previously observed data), etc.

In operation S5060, the analysis server 132 may calculate the probability that the current data point is a changepoint based on the calculated growth probabilities of each of the previous data points of the current distribution up to the current data point, the predicted probability of the current data point (calculated in operation S5040), and the probability that the hazard function has occurred. The analysis server 132 may calculate the changepoint probability of the current data point using the following equation, but is not limited thereto:

$$P ( {r}_{t} = 0 , x \text{?} ) = {\sum }_{\text{?}} P ( \text{?} ) {π}_{t}^{( r )} H ( \text{?} ) \qquad [ Equation 3 ]$$

$$\text{?} \text{indicates text missing or illegible when filed}$$

Next, the analysis server 132 may sum the calculated growth probabilities and the changepoint probabilities of each previous data point and the current data point, or in other words, calculate the evidence of the change point occurring during the current run. If the calculated sum is greater than a desired threshold, e.g., 0.1, etc., the analysis server 132 will increment the current run-length counter by 1, and if the sum is equal to or below the desired threshold, the analysis server 132 will reset the run-length counter to 0. The analysis server 132 may then determine the run length distribution of the observed data points of the current run (e.g., calculate the posterior distribution of the counter) using the following equation, but is not limited thereto:

[symbol]

### [Equation 4]

Additionally, the analysis server 132 may update the hyperparameters for the distribution as a function of the previous parameters and the next datapoint.

In operation S5070, the analysis server 132 may determine whether there are any additional data points for the co-tuple time series. If there are additional data points in the co-tuple time series, the analysis server 132 moves to operation S5030. If there are no additional data points in the co-tuple time series, the analysis server 132 will then move to operation S5080. In operation S5080, the analysis server 132 may determine the changepoints in the co-tuple transaction time series. More specifically, the analysis server 132 defines a desired baseline level of trading activity for the co-tuple combination (e.g., a desired changepoint detection threshold, etc.) which acts as a baseline representing “normal trading activity” for determining whether a data point is considered to be an actual changepoint, and a desired changepoint run-length percentage which indicates how many data points of the previous run-lengths to review and/or analyze to calculate and/or determine if the current data point is a changepoint. In at least one example embodiment, the desired baseline level may be set to “0.1” and the desired changepoint run-length percentage may be set to “20%,” but the example embodiments are not limited thereto. Next, the analysis server 132 may sum up the calculated growth and changepoint probabilities for each datapoint of the co-tuple transaction time series being analyzed based on the desired changepoint run-length percentage, e.g., sum up the growth and changepoint probabilities datapoints of the last 20% of data points of the current run, and then comparing these sums with the desired baseline level, e.g., 0.1, but the example embodiments are not limited thereto. If the analysis server 132 determines that the sums of the probabilities is less than the desired baseline level, a changepoint has occurred at the current data point being observed, e.g., χₜ, but if the sum is greater than the desired baseline level, no changepoint has occurred. One or both of the desired baseline level and the desired changepoint run-length percentage may be included in the changepoint analysis parameters, and may be user-defined, tuned, and/or automatically tuned based on previous runs of the changepoint detection analysis, etc., but the example embodiments are not limited thereto.

In operation S5090, the analysis server 132 may store the determined changepoints of the co-tuple transaction time series in memory.

FIG. 6 illustrates an example method for performing “online” changepoint analysis for an individual co-tuple combination according to at least one example embodiment.

In operation S6010, for each user account, the analysis server 132 may generate at least one co-tuple transaction time series from newly received raw data, e.g., at least one new transaction, etc., included in an updated raw dataset received from the trading server 131 based on the time series parameters, such as the desired co-tuple size, desired sliding window size, etc., but the example embodiments are not limited thereto. The analysis server 132 may receive the updated raw dataset on a real-time basis, a near-real-time basis, and/or at a desired periodic time interval, etc., but the example embodiments are not limited thereto. The analysis server 132 may generate the new co-tuple transaction time series for each user account using the operations S4010 to S4050 of FIG. 4A, but the example embodiments are not limited thereto.

In operation S6020, the analysis server 132 may generate at least one second transaction time series by aggregating all of the new co-tuple transactions corresponding to each co-tuple group (e.g., co-tuple combination, etc.), similar to and/or the same as operation S4060 of FIG. 4A, but is not limited thereto. In operation S6030, the analysis server 132 may retrieve the stored first transaction time series and/or the stored first changepoint data from memory (e.g., the previously generated transaction time series and/or the previously generated changepoint data) for a selected co-tuple group (e.g., Microcap A and Microcap B, Microcap B and Microcap C, etc.). In operation S6040, the analysis server 132 may perform updated (e.g., online) changepoint analysis on the second transaction time series data (e.g., the new transaction time series data, etc.) based on the changepoint analysis parameters, the stored first transaction time series, and the stored first changepoint data for the selected co-tuple group, etc. In other words, instead of generating transaction time series and performing changepoint analysis on the entire transaction dataset, including the new transactions data, the analysis server 132 may instead generate new transaction time series on only the new transaction data and/or perform changepoint detection analysis on the new transaction data, while relying on the previously generated time series and previously performed changepoint detection analysis, etc., thereby reducing the amount of processing and time required to perform the online changepoint analysis on the new transaction data, etc. More specifically, the analysis server 132 may perform a modified version of the operation S5020 of FIG. 5, wherein assuming that the last datapoint contained in the stored first transaction time series was not a changepoint, the analysis server 132 may omit initializing the changepoint run-length counter for the last of the stored transaction time series to zero, and instead import the changepoint run-length counter for the last of the stored transaction time series, and use the first datapoint of the newly generated time series corresponding (e.g., the generated second time series) to the new raw transaction data as the new data point of operation S5030. Further, the analysis server 132 may also import the calculated predicted probability values, calculated growth probability values, and/or calculated changepoint probabilities of the datapoints included in the last run of the stored changepoint data for use in performing operations S5040, S5050, S5060, S5070, and/or S5080 of FIG. 5 on the new transaction time series, etc., but the example embodiments are not limited thereto.

In operation S6050, the analysis server 132 may store the updated aggregated time series and/or the updated changepoint data in memory. Additionally, the analysis server 132 may determine whether there are any additional co-tuple groups, and if yes, the analysis server 132 may move to operation S6030. If there are no additional co-tuple groups, the analysis server 132 may move to operation S3060 of FIG. 3A.

While FIGS. 3A, 4A and 5 to 6 illustrate various methods for performing co-trading changepoint detection to detect artificial market manipulation and/or potential artificial market manipulation in the price of co-traded securities, the example embodiments are not limited thereto, and other methods may be used and/or modifications to the methods may be used to perform the detection of artificial market manipulation and/or potential artificial market manipulation of the example embodiments.

Various example embodiments are directed towards an improved device, system, method and/or non-transitory computer readable medium for detecting potential artificial market manipulation by analyzing co-trading time series data of groups of two or more securities of a plurality of trading accounts over desired sliding time windows which provides more accurate detection of potential artificial market manipulation and/or provides reduced numbers of false positive identification of potential artificial market manipulation. At least one example embodiment provides for determining potential victims and/or perpetrators of artificial price manipulation based on the detection of suspicious trading activity and/or potential artificial market manipulation. Additionally, according to at least some example embodiments, the detection of potential artificial price manipulation behavior may be performed on historical data stored on the online trading platform and/or may be performed in real-time and/or near real-time on incoming trading transactions processed by the online trading platform, etc. Further, according to some example embodiments, the detection of potential artificial price manipulation behavior on an online and/or streaming basis, wherein the analysis is performed on new data as the new data arrives, without re-calculating previous analysis, etc.

Additionally, according to some example embodiments, a search and/or investigation (e.g., an automated search and/or investigation) may be performed for external factors associated with the identified securities which may have caused and/or impacted the increased suspicious trading activity, etc., during the relevant time period(s) corresponding to the determined changepoints, such as company press releases affecting the stock price, regulatory changes affecting the relevant industry, etc., to further reduce potential false positive identifications, etc.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A server for performing co-trading changepoint detection, the server comprising:
a memory storing computer readable instructions; and
processing circuitry configured to execute the computer readable instructions to cause the server to,
receive a first raw dataset, the first raw dataset including a plurality of transactions for analysis, each transaction of the plurality of transactions associated with a user account of a plurality of user accounts,
generate at least one transaction time series based on the first raw dataset,
determine changepoints in the first raw dataset by performing changepoint detection analysis on the generated at least one transaction time series, and
generate at least one potential fraud alert based on the determined changepoints.

2. The server of claim 1, wherein the processing circuitry is further configured to execute the computer readable instructions to cause the server to:
receive a desired set of filtering parameters, the desired set of filtering parameters including at least a set of desired transaction object identifiers and a desired transaction type identifier; and
filter the first raw dataset using the desired set of filtering parameters to form a filtered first dataset.

3. The server of claim 2, wherein the processing circuitry is further configured to execute the computer readable instructions to cause the server to:
receive a desired set of time series parameters, the desired set of time series parameters including a desired analysis sliding time window size, and a desired co-tuple size, the desired co-tuple size being an integer greater than 1; and
generate the at least one transaction time series based on the filtered first dataset and the desired set of time series parameters.

4. The server of claim 3, wherein the processing circuitry is further configured to execute the computer readable instructions to cause the server to:
for each user account included in the filtered first dataset,
generate a second set of transactions from the filtered first dataset, each of the second set of transactions associated with the user account;
determine at least one co-tuple group, the at least one co-tuple group being a combination of transaction object identifiers from the set of desired transaction object identifiers based on the desired co-tuple size;
for each co-tuple group, determine co-tuple group transactions from the second set of transactions associated with transaction object identifiers included in the co-tuple group based on the desired analysis slide time window size; and
generate the at least one transaction time series by aggregating the determined co-tuple group transactions associated with the user account.

5. The server of claim 1, wherein the processing circuitry is further configured to execute the computer readable instructions to cause the server to:
receive a desired set of changepoint parameters, the desired set of changepoint parameters including at least a desired probability distribution type, a desired set of hyperparameters associated with the desired probability distribution type, and a desired hazard function;
for each co-tuple transaction included in the generated at least one transaction time series,
calculate a predicted probability value of the co-tuple transaction based on the desired probability distribution type and the desired set of hyperparameters,
determine a growth probability value of the co-tuple transaction based on the calculated predicted probability value, a current changepoint run length, and the desired hazard function,
calculate a changepoint probability value of the co-tuple transaction based on the determined growth probability value and a sum of the calculated predicted probability values of previous co-tuple transactions of the current changepoint run length, and
determine whether the co-tuple transaction is a changepoint based on the calculated changepoint probability value and a desired changepoint threshold value; and
store the determined changepoints.

6. The server of claim 5, wherein the processing circuitry is further configured to execute the computer readable instructions to cause the server to:
receive new transactions for analysis in real-time;
update the at least one transaction time series based on the received new transactions; and
determine new changepoints based on the updated at least one transaction time series and the stored determined changepoints.

7. The server of claim 1, wherein the processing circuitry is further configured to execute the computer readable instructions to cause the server to:
identify the user accounts associated with the transactions corresponding to the determined changepoints; and
generate the at least one potential fraud alert, the at least one potential fraud alert including the identified user accounts and the transactions corresponding to the determined changepoints.

8. The server of claim 7, wherein the server is further configured to execute the computer readable instructions to cause the server to:
transmit the at least one potential fraud alert to at least one of the user account associated with the potential fraud alert, a fraud investigation service, a government agency, or any combinations thereof.

9. A method of performing co-trading changepoint detection, the method comprising:
receiving a first raw dataset, the first raw dataset including a plurality of transactions for analysis, each transaction of the plurality of transactions associated with a user account of a plurality of user accounts;
generating at least one transaction time series based on the first raw dataset;
determining changepoints in the first raw dataset by performing changepoint detection analysis on the generated at least one transaction time series; and
generating at least one potential fraud alert based on the determined changepoints.

10. The method of claim 9, further comprising:
receiving a desired set of filtering parameters, the desired set of filtering parameters including at least a set of desired transaction object identifiers and a desired transaction type identifier; and
filtering the first raw dataset using the desired set of filtering parameters to form a filtered first dataset.

11. The method of claim 10, further comprising:
receiving a desired set of time series parameters, the desired set of time series parameters including a desired analysis sliding time window size, and a desired co-tuple size, the desired co-tuple size being an integer greater than 1; and
generating the at least one transaction time series based on the filtered first dataset and the desired set of time series parameters.

12. The method of claim 11, further comprising:
for each user account included in the filtered first dataset,
generating a second set of transactions from the filtered first dataset, each of the second set of transactions associated with the user account;
determining at least one co-tuple group, the at least one co-tuple group being a combination of transaction object identifiers from the set of desired transaction object identifiers based on the desired co-tuple size;
for each co-tuple group, determining co-tuple group transactions from the second set of transactions associated with transaction object identifiers included in the co-tuple group based on the desired analysis slide time window size; and
generating the at least one transaction time series by aggregating the determined co-tuple group transactions associated with the user account.

13. The method of claim 9, further comprising:
receiving a desired set of changepoint parameters, the desired set of changepoint parameters including at least a desired probability distribution type, a desired set of hyperparameters associated with the desired probability distribution type, and a desired hazard function;
for each co-tuple transaction included in the generated at least one transaction time series,
calculating a predicted probability value of the co-tuple transaction based on the desired probability distribution type and the desired set of hyperparameters,
determining a growth probability value of the co-tuple transaction based on the calculated predicted probability value, a current changepoint run length, and the desired hazard function,
calculating a changepoint probability value of the co-tuple transaction based on the determined growth probability value and a sum of the calculated predicted probability values of previous co-tuple transactions of the current changepoint run length, and
determining whether the co-tuple transaction is a changepoint based on the calculated changepoint probability value and a desired changepoint threshold value; and
storing the determined changepoints.

14. The method of claim 13, further comprising:
receiving new transactions for analysis in real-time;
updating the at least one transaction time series based on the received new transactions; and
determining new changepoints based on the updated at least one transaction time series and the stored determined changepoints.

15. The method of claim 9, further comprising:
identifying the user accounts associated with the transactions corresponding to the determined changepoints; and
generating the at least one potential fraud alert, the at least one fraud alert including the identified user accounts and the transactions corresponding to the determined changepoints.

16. A non-transitory computer readable medium storing computer readable instructions, which when executed by processing circuitry of a server, causes the server to:
receive a first raw dataset, the first raw dataset including a plurality of transactions for analysis, each transaction of the plurality of transactions associated with a user account of a plurality of user accounts;
generate at least one transaction time series based on the first raw dataset;
determine changepoints in the first raw dataset by performing changepoint detection analysis on the generated at least one transaction time series; and
generate at least one potential fraud alert based on the determined changepoints.

17. The non-transitory computer readable medium of claim 16, wherein the server is further caused to:
receive a desired set of filtering parameters, the desired set of filtering parameters including at least a set of desired transaction object identifiers and a desired transaction type identifier; and
filter the first raw dataset using the desired set of filtering parameters to form a filtered first dataset.

18. The non-transitory computer readable medium of claim 17, wherein the server is further caused to:
receive a desired set of time series parameters, the desired set of time series parameters including a desired analysis sliding time window size, and a desired co-tuple size, the desired co-tuple size being an integer greater than 1; and
generate the at least one transaction time series based on the filtered first dataset and the desired set of time series parameters.

19. The non-transitory computer readable medium of claim 18, wherein the server is further caused to:
for each user account included in the filtered first dataset,
generate a second set of transactions from the filtered first dataset, each of the second set of transactions associated with the user account;
determine at least one co-tuple group, the at least one co-tuple group being a combination of transaction object identifiers from the set of desired transaction object identifiers based on the desired co-tuple size;
for each co-tuple group, determine co-tuple group transactions from the second set of transactions associated with transaction object identifiers included in the co-tuple group based on the desired analysis slide time window size; and
generate the at least one transaction time series by aggregating the determined co-tuple group transactions associated with the user account.

20. The non-transitory computer readable medium of claim 16, wherein the server is further caused to:
receive a desired set of changepoint parameters, the desired set of changepoint parameters including at least a desired probability distribution type, a desired set of hyperparameters associated with the desired probability distribution type, and a desired hazard function;
for each co-tuple transaction included in the generated at least one transaction time series,
calculate a predicted probability value of the co-tuple transaction based on the desired probability distribution type and the desired set of hyperparameters,
determine a growth probability value of the co-tuple transaction based on the calculated predicted probability value, a current changepoint run length, and the desired hazard function,
calculate a changepoint probability value of the co-tuple transaction based on the determined growth probability value and a sum of the calculated predicted probability values of previous co-tuple transactions of the current changepoint run length, and
determine whether the co-tuple transaction is a changepoint based on the calculated changepoint probability value and a desired changepoint threshold value; and
store the determined changepoints.
